(19) United States
(12) Patent Application Publication
(10) Pub. No.: US 2025/0120861 A1
(43) Pub. Date: Apr. 17, 2025

(54) ALTERNATING-PRESSURE SUPPORT AND PATIENT BED, AND METHOD FOR OPERATION

(71) Applicant: Nocubi AG, Tägerwilen (CH)

(72) Inventor: Markus Spalek, Reutlingen (DE)

(21) Appl. No.: 18/682,529

(22) PCT Filed: Aug. 8, 2022
(86) PCT No.: PCT/EP2022/072282

§ 371 Date: Feb. 9, 2024

(30) Foreign Application Priority Data
Aug. 9, 2021 (DE) 10 2021 120 696.0

(51) Int. Cl. A61G 7/057

(52) U.S. Cl. CPC A61G 7/0573

(57) ABSTRACT

An alternating-pressure support includes a plurality of support elements and a guide arrangement with at least two guides that are opposite one another in a transverse direction and extend in a longitudinal direction. The support elements are movably mounted at opposite ends in the guides. The support elements are configured for elastically supporting a load impacting them, i.e. a load borne by the alternating-pressure support. A patient bed having such an alternating-pressure support and a method for operating such an alternating-pressure support are also provided.

The present invention relates to an alternating-pressure support, a patient bed having such an alternating-pressure support and a method for the operation of such an alternating-pressure support.

In home-based and/or professional care of bedridden patients, the problem of patients getting bedsores (“decubitus”) can occur. In this scenario, there is local damage to the skin and to the tissue under it due to prolonged pressure, which disrupts the blood supply to the skin.

To counteract this problem, “decubitus mattresses” (also referred to as anti-decubitus mattresses) are known, these being intended to achieve a reduction in the maximum bearing pressure, e.g. by means of a larger bearing surface for the patient or a lying position in which pressure distribution is more uniform. Alternatively or in addition, these mattresses can have an alternating-pressure system by means of which points on the body can be alternately subjected to or relieved of a load in order to avoid persistent disruption of the blood supply. In general, these alternating-pressure systems comprise a plurality of air chambers which can be selectively supplied with air or in which the air pressure can be adapted.

It is an object of the present invention to specify an alternative to known anti-decubitus systems. In particular, it is an object of the invention to improve the comfort of patients on such anti-decubitus systems and/or to increase the effectiveness of anti-decubitus systems.

This object is achieved by an alternating-pressure support and a patient bed having an alternating-pressure support of this kind and by a method for the operation of an alternating-pressure support of this kind in accordance with the independent claims.

Advantageous embodiments form the subject matter of the dependent claims and of the following description.

According to a first aspect of the invention, an alternating-pressure support, in particular for preventing decubitus, has a plurality of support elements and a guide arrangement with at least two guides, which are arranged opposite one another in a transverse direction and extend in a longitudinal direction and in which the support elements are movably mounted at opposite ends. According to the invention, the support elements are designed for elastically supporting a load acting upon them, i.e. a load supported by the alternating-pressure support, on the guide arrangement.

Movable support in the sense according to the invention should be understood, in particular, to mean that the support elements can be moved along the longitudinal direction, i.e. in the longitudinal direction and/or counter to the longitudinal direction, in particular in translation. Movable support expediently allows both rolling circulation of the support elements and an oscillatory backward and forward movement.

Elastic support of a load in the sense according to the invention should be understood to mean, in particular, sprung or damped support of the load. Here, the elastic support is expediently achieved by means of elastic deformability of the supporting or bearing element. Support elements configured for elastic support can, for example, be deformed in some section or sections or at a certain point or points, depending on the load. When the action of the load ceases, the support elements expediently reassume their original shape.

One aspect of the invention is based on the approach of providing an alternating-pressure support having support elements which preferably define a lying or sitting surface of the alternating-pressure support. Here, the support elements are expediently configured for elastic support of a load borne by the alternating-pressure support, and therefore the lying or sitting surface is elastically deformable, preferably sprung, in particular spring-damped. It is preferable, in addition, if the support elements can be moved, with the aid of a guide arrangement comprising two guides, along a longitudinal direction, e.g. under a patient lying on the alternating-pressure support. In other words, provision can be made, in the case of a movement relative to the patient, for the support elements, which preferably extend in a transverse direction, to be able to roll or slide under the patient and to adapt at least in some section or sections to a silhouette of the patient in accordance with the load. Continuous or at least intermittent alteration of the bearing pressure and, at the same time, comfortable support for the patient is thus made possible. In this way, the formation of bedsores can be counteracted effectively or, where decubitus has already occurred, worsening of the symptoms can be prevented or at least delayed. At the same time, uniform distribution of the bearing pressure and thus high comfort for the patient when lying or sitting is made possible.

In this case, the support elements are preferably configured to elastically support the patient on the guide arrangement, in particular the two mutually opposite guides. Each support element is preferably movably mounted at its two mutually opposite ends in the two guides, which are arranged opposite one another in a transverse direction running transversely to the longitudinal direction. The weight of the patient can thereby be borne by the guides. Here, shocks can be damped by the support elements in order to preserve the guides. At the same time, the support elements can define a soft lying or sitting surface. In this case, the guides preferably run in the longitudinal direction, thus enabling the support elements to move in and/or counter to the longitudinal direction.

During this movement of the support elements, the bearing points along the body of the patient can vary substantially continuously or at least intermittently in order not only to avoid or at least reduce disruption of the blood supply but also to promote the blood supply to the skin, in particular the functioning of veins. In particular, it is even possible to stroke blood vessels. This promotion of blood flow can also counteract thrombosis. In other words, the alternating-pressure support additionally allows prophylaxis of thrombosis and an improvement in lymph drainage.

In principle, the diameters of the support elements and the spacings between the individual support elements, in particular along the longitudinal direction, relative to one another can be chosen according to the size of the patient and/or the weight of the patient. These support element diameters and these support element spacings are preferably chosen in such a way that comfortable support of the body weight is achieved but, at the same time, sufficient skin areas are completely relieved of load and thus supplied with blood. These effects can be achieved, for example, by means of support element diameters which have a length of between 1 cm and 20 cm, preferably between 2 cm and 10 cm, in particular of about 5 cm, in the longitudinal direction, wherein the support element spacings can be between 1 cm and 45 cm, preferably between 2 cm and 15 cm, in particular about 8 cm.

As already indicated above, the alternating-pressure support can be used as a “slatted frame” in order to support thereon a patient at risk of decubitus. However, it is also conceivable to use an appropriately dimensioned alternating-pressure support as a sitting surface or at least as a sitting support or “seat cushion”, for instance in a wheelchair, armchair, car seat and/or the like. Alternatively or in addition, an alternating-pressure support of this kind can also be used in the case of long operations as a leg support or as a support for the entire body for example, for instance in order to ensure a sufficient blood supply to the legs and/or other parts of the body.

Preferred embodiments of the invention and developments thereof are described below, and, unless explicitly excluded, these can each be combined in any way desired with one another and with the aspects of the invention that are described below.

In a preferred embodiment, at least some of the support elements are of elastic design, at least in some section or sections. For example, individual or even all of the support elements can at least partially comprise an elastic material or an elastic structure, which, for example, allows deformation of the support elements according to the bearing pressure. In particular, it is conceivable in this context that a support roller of one or more support elements is of fully elastic design, e.g. being manufactured from an elastic material. Through such a design of at least some of the support elements, it is possible to achieve elastic support of a load with a particularly low complexity and in a particularly space-saving manner.

In another preferred embodiment, at least some of the support elements have a respective supporting arrangement. In this case, the supporting arrangement is expediently elastically deformable, at least in some section or sections. In particular, the supporting arrangement can be of bendable and/or compressible design, at least in some section or sections. The supporting arrangement can be designed as a damping or spring mechanism, for example, in order to be able to absorb at least some of the forces acting, e.g. in the case of shocks. The supporting arrangement is preferably integrated into the support elements, e.g. built into the support elements, in particular being arranged in the interior of the support elements. By providing one or more supporting arrangements, a softness of the lying or sitting surface defined by the support elements can be easily and selectively adjusted. If required, it is also possible to make the supporting arrangements exchangeable in order to be able to adapt the softness when necessary. At the same time, supporting arrangements integrated into the support elements can be protected more easily from external influences and thus damage.

In another preferred embodiment, the supporting arrangement—or each of the supporting arrangements—has a base for rotationally secure connection to an axial part of the support element and a sleeve for rotationally secure connection to a shell of the support element. This can facilitate the integration of the supporting arrangement into the support element. For example, the base can easily be slipped directly onto an axle element of the support element or else onto a hub or a bearing arrangement which allows rotation of the supporting arrangement around the axle element.

The base is connected to the sleeve, expediently by at least one elastically deformable element, e.g. by one or more springs, elastic structures such as webs or pillars, or elastic bodies such as foam bodies. This allows a compact and, at the same time, stable construction of the supporting arrangement.

In another preferred embodiment, at least some of the support elements have a respective axle element and at least one support roller, preferably for supporting the load. The axle element is preferably manufactured from steel in order to have a sufficient bending and/or breaking strength. Alternatively, to save weight, it is also possible for the axle element to be manufactured from some other material, preferably aluminum, and/or to be in the form of a hollow profile. The axle element is expediently of a rod-type design and/or is dimensioned in such a way that it extends in the transverse direction from one of the two guides to the opposite of the one of the two guides. The axle element preferably has a diameter of between 0.5 cm and 2 cm, in particular between 0.5 cm and 1 cm.

The support roller preferably has a lateral surface which is configured to support the load. The support elements are expediently arranged and/or the support rollers are designed in such a way, in particular dimensioned in such a way, that a horizontal tangent of the lateral surfaces of at least one part of the support rollers defines a substantially level—and therefore particularly comfortable—sitting or lying surface. Alternatively, however, it is also conceivable for the support elements to be arranged in such a way and/or for the support rollers to be designed in such a way, in particular dimensioned in such a way, that horizontal tangents of various lateral surfaces lie in various mutually parallel horizontal planes. For example, the lateral surfaces of the support rollers can alternately have different diameters. It is thereby possible to define a sitting or lying surface which is uneven and, as a result, particularly effective in promoting the blood supply.

The support roller is expediently connected elastically to the axle element. In other words, the support roller is expediently supported elastically on the axle element. As a result, during a movement in or counter to the longitudinal direction, the support rollers can roll under a patient sitting or lying on them and, at the same time, achieve sprung and thus comfortable support for the patient.

In another preferred embodiment, the support roller is designed, at least in some section or sections, as a round tube around the axle element. In this case, the supporting arrangement is expediently arranged between the axle element and the support roller. In other words, the supporting arrangement is expediently arranged in the cavity between the axle element and the round tube. In this case, the supporting arrangement preferably supports the support roller on the axle element. The supporting arrangement can thereby be protected from external influences and, at the same time, can cushion a load acting on the support element over the entire width of the support element.

In the unloaded state, the support roller and the axle element are preferably arranged coaxially. Under load, with elastic deformation of the supporting arrangement, the axis of symmetry of the support roller expediently moves relative to the rotational axis defined by the axle element.

In another preferred embodiment, the supporting arrangement is seated on the axle element. In addition, the support roller is expediently seated on the supporting arrangement. In this case, the supporting arrangement can be seated directly or indirectly on the axle element. For example, the supporting arrangement can be seated directly and in a rotationally secure manner on the axle element. Alternatively, a hub or a bearing arrangement can be arranged between the supporting arrangement and the axle element in order to enable rotation of the supporting arrangement—and hence also of the support roller—relative to the axle element.

In another preferred embodiment, at least some of the support elements have in each case at least one elastically deformable, preferably elastically compressible, foam body. Here, the foam body can be manufactured from polyurethane foam (PU foam), cold-cure foam and/or a 3D printed structure. In this case, the foam body expediently forms at least part of the supporting arrangement. For example, the foam body can fill the cavity between the support roller designed as a round tube and the axle element. The elastic support of a load by the support elements can thus be implemented in a particularly weight-saving manner. At the same time a foam body enables particularly uniform damping, relative to the circumference of the support element.

Alternatively or in addition to the foam body, it is also possible to provide a gas-filled, in particular air-filled, hose. Here, the gas contained in the hose is preferably subjected to a predetermined pressure. The elastic support can thus be implemented in a manner which is particularly low in complexity and economical.

In another preferred embodiment, at least some of the support elements have in each case at least one elastically deformable, preferably bendable, profile. In this context, a profile is understood, in particular, to mean an elongate component which has axially extending recesses, e.g. in the form of grooves, on the surface or even cavities in the interior. By means of a profile, it is possible to achieve a weight saving relative to a solid body.

The profile is expediently manufactured from an elastically deformable material, e.g. silicone. The profile preferably has load-bearing struts. These struts are preferably dimensioned in such a way that they bend elastically under the action of a load. As a result, the profile can be manufactured in a very compact form.

In another preferred embodiment, the profile is of star-shaped design in cross section, in particular perpendicularly to a longitudinal extent. That is to say that load-bearing struts expediently extend radially outward in a star shape. It is thereby possible to achieve an elastic deformability of the profile which is substantially uniform, i.e. the same over the circumference.

In another preferred embodiment, at least some of the support elements have a respective spring arrangement, expediently comprising a plurality of springs, in particular compression springs or tension springs. The spring arrangement is preferably of star-shaped design. For example, individual springs can be aligned radially. By means of a spring arrangement, it is possible to adjust the elasticity of the support elements particularly accurately.

In another preferred embodiment, each of the support elements has an axle element and, at each of the opposite ends, a respective running roller for movable mounting in the respective guide. The running rollers are expediently connected elastically to the axle element. In other words, the running rollers are expediently supported elastically on the axle element. For example, a respective supporting arrangement can be provided for each of the running rollers, similarly to a vehicle with shock dampers. Providing elastically mounted running rollers makes it possible to save installation space.

In this case, the running rollers can be mounted so as to be rotatable about the axle element, e.g. by means of a corresponding bearing arrangement, for instance a ball bearing. Alternatively, however, it is also conceivable for the running rollers to be seated in a rotationally secure manner on the axle element. In this case, the axle element simultaneously rotates as the running rollers roll in the guides. In order to enable a rolling movement under a patient on the alternating-pressure support during this process, the support rollers are preferably mounted so as to be rotatable about the respective axle element.

In another preferred embodiment, the alternating-pressure support is configured for an oscillatory motion of the support elements along and counter to the longitudinal direction in alternation. In this case, the alternating-pressure support is preferably configured for actively driven, in particular motor-driven, movement of the support elements. For this purpose, the alternating-pressure support can have a drive, in particular a motor. The limitation to an oscillatory motion has the advantage over a rolling (recirculating) system that no return is required for the support elements. By virtue of the saving of installation space thereby achieved, an alternating-pressure support with an oscillatory motion of the support elements is suitable particularly for use in wheelchairs, for example.

According to a second aspect of the invention, a patient bed has a frame and an alternating-pressure support according to the first aspect of the invention, which is supported by the frame. In this case, the alternating-pressure support can replace a conventional slatted frame and, in particular, can be inserted into the frame instead of a conventional slatted frame.

In this case, the alternating-pressure support can be configured for nondestructive, in particular tool-free, detachable connection to the frame. For example, the alternating-pressure support can have a latching or clip mechanism by means of which the alternating-pressure support can be fastened on the frame or hooked into the frame, in particular latched or clipped in. This enables the alternating-pressure support optionally also to be used with conventional patient beds. In particular, conventional patient beds can be fitted or retrofitted with an alternating-pressure support for the prevention of decubitus. At the same time, the alternating-pressure support can also be removed again quickly when necessary.

According to a third aspect of the invention, in a method for the operation of an alternating-pressure support, in particular according to the first aspect of the invention, a plurality of support elements is moved in at least two guides of a guide arrangement, which are arranged opposite one another in a transverse direction and extend in a longitudinal direction. In this case, the support elements are movably mounted at opposite ends in the guides and elastically support a load acting upon them on the guides.

In this case, the movement of the support elements can be accomplished by means of a motor drive device and/or manually, e.g. by means of a manually actuable drive device. Control of the movement is preferably exercised by a control device, which can control the motor drive device in an appropriate manner. In particular, it is possible to conceive of different operating modes, e.g. a recirculating movement of the support elements, an (oscillatory) backward and forward movement of the support elements, a continuous movement of the support elements and/or an intermittent movement of the support elements.

The invention is explained in greater detail below with reference to figures. Insofar as it is expedient, elements that have the same action are provided herein with the same reference signs. The invention is not limited to the exemplary embodiments illustrated in the figures, and is also not limited in respect of functional features. The description given hitherto and the following description of the figures contain numerous features which are in some cases reproduced together in groups in the dependent claims. These features and also all the other features disclosed above and in the following description of the figures will however also be considered individually and combined to give further expedient combinations by a person skilled in the art. In particular, all the features mentioned can each be combined individually and in any suitable combination with the alternating-pressure support according to the first aspect of the invention, the patient bed according to the second aspect of the invention and the method according to the third aspect of the invention.

Of the figures, which are at least in part schematic:

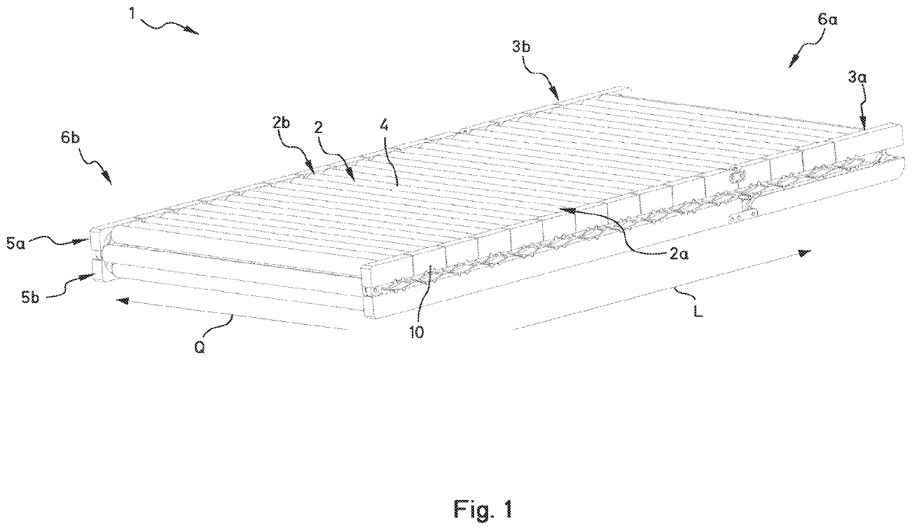

FIG. 1 shows an example of an alternating-pressure support with recirculating support elements;

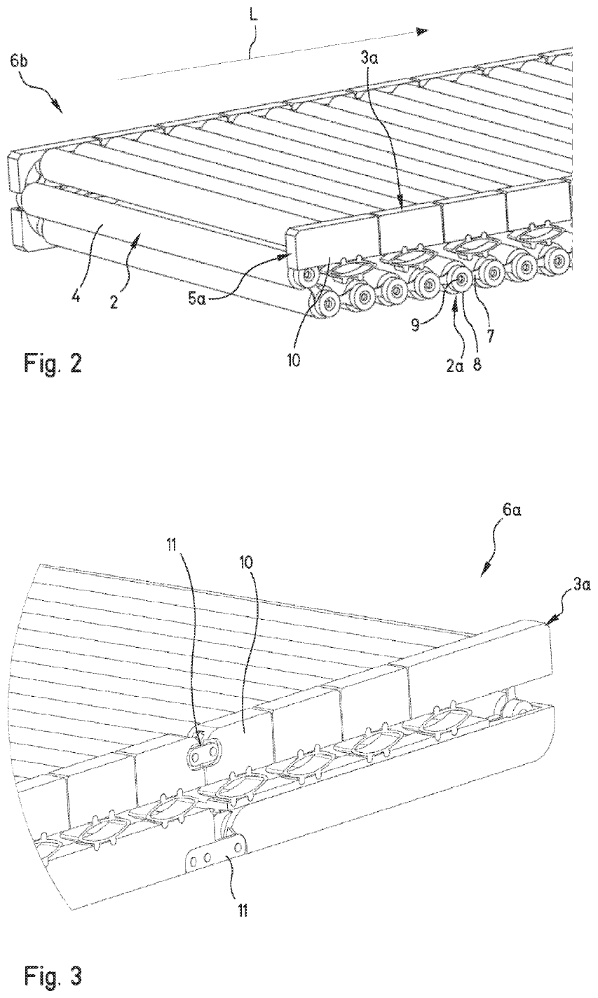

FIG. 2 shows a detail of FIG. 1 in the region of the foot part of the alternating-pressure support without showing the return;

FIG. 3 shows a detail of FIG. 1 in the region of the head part of the alternating-pressure support;

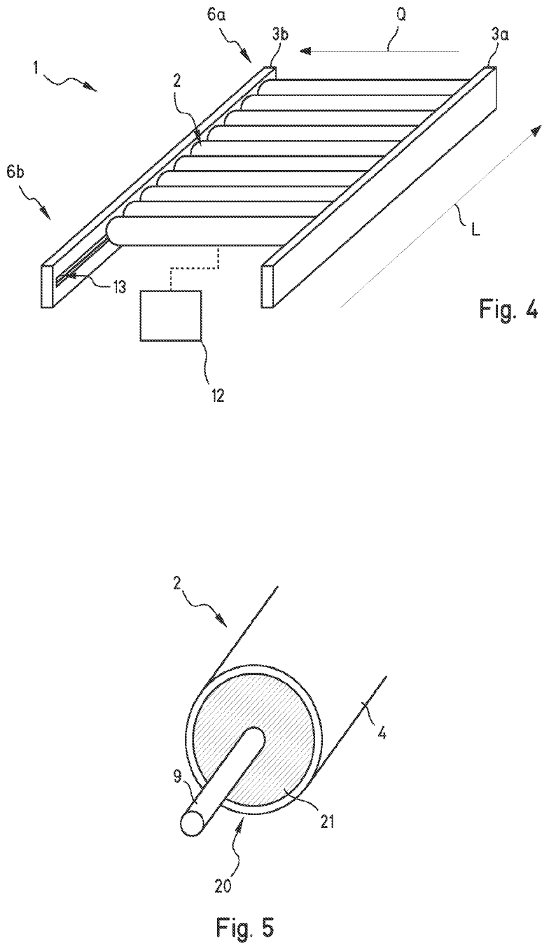

FIG. 4 shows an example of an alternating-pressure support without a return;

FIG. 5 shows an example of a support element;

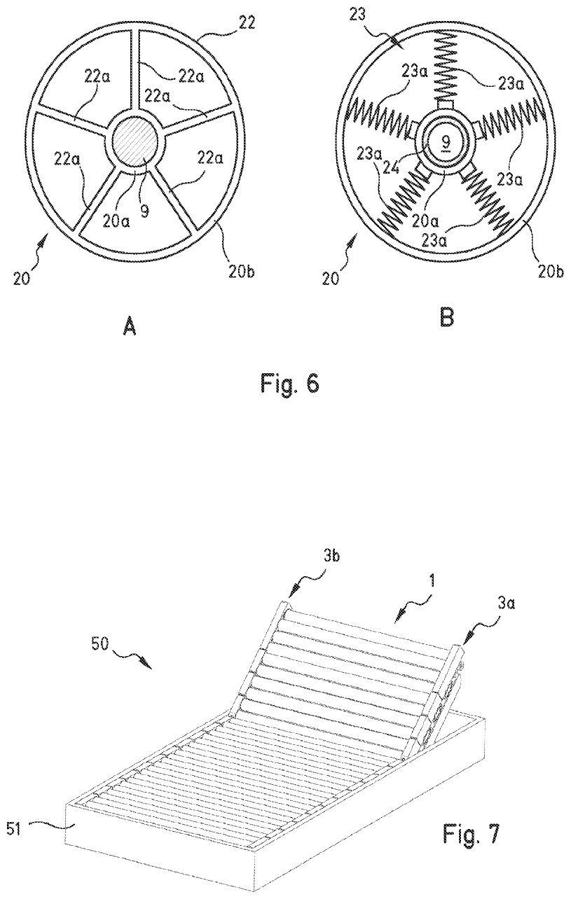

FIG. 6 shows examples of supporting device in a cross section; and

FIG. 7 shows an example of a patient bed.

FIG. 1 shows an example of an alternating-pressure support 1 for preventing decubitus, having a plurality of support elements 2 arranged one behind the other along a longitudinal direction L. The alternating-pressure support 1 has a guide arrangement with two guides 3a, 3b arranged opposite one another, wherein the support elements 2 are mounted movably in the two guides 3a, 3b at their two opposite ends 2a, 2b. In other words, the guides 3a, 3b and the support elements 2 are designed in such a way that the support elements 2 can be moved in or counter to the longitudinal direction L with the aid of the guides 3a, 3b.

At the same time, the support elements 2 are designed for elastically supporting a load acting upon them, i.e. a load supported by the alternating-pressure support, on the guide arrangement. For this purpose, the support elements 2 are expediently designed to be elastically deformable, at least in some section or sections. For example, the support elements 2 can each have at least one elastically deformable supporting arrangement (see FIG. 5). As a result, it is possible, for example, for the lateral surface of the support elements 2 to yield when a patient lies or sits down on the alternating-pressure support 1. The patient can thus be supported “elastically”, i.e. in a sprung or damped manner.

In the example shown, each of the support elements 2 has a support roller 4, which is mounted so as to be freely rotatable about a rotational axis aligned transversely to the longitudinal direction L, that is to say extending parallel to a transverse direction Q. The rotational axes of the support rollers 4 can be defined, for example, by the longitudinal axes of axle elements (not visible in FIG. 1), onto which the support rollers 4 can be fitted or slipped, for example.

However, it is also conceivable, instead of the support rollers 4, to provide sliding elements (not shown), which are designed to slide under the patient. Such sliding elements can, for example, have a sliding surface and/or an oval cross section in order to facilitate sliding or at least to reduce sliding friction.

As shown in FIG. 1, the alternating-pressure support 1 forms a kind of slatted frame, on which a patient susceptible to decubitus, e.g. an at least partially paralyzed or otherwise immobile patient, can be supported. Owing to the movable mounting of the support elements 2, the “slats” of this frame are not arranged in a stationary or static manner but are arranged in a variable location or dynamically. This mobility of the support elements 2 allows pressure to be applied to the supported patient in a varying location, making it possible to effectively and reliably counteract (persistent) local disruption of the blood supply and associated local tissue damage and even necrosis.

However, as a departure from what is shown in FIG. 1, an alternating-pressure support of this kind can also be used—possibly with different dimensions—in other ways, e.g. as a sitting surface or support or as a leg rest.

In the embodiment shown in FIG. 1, the support rollers 4 of the support elements 2 are configured to support the patient elastically, wherein the support elements 2 in turn are supported by the guide arrangement, e.g. through the two ends 2a, 2b of each of the support elements 2 being seated in the guides 3a, 3b. In the case of a movement of the support elements 2 in the longitudinal direction L, the support rollers 4 can roll under the patient by virtue of their free rotational support. In other words, the support rollers 4 ensure that the support elements 2 can be moved relative to a patient supported by the support rollers 4. In this case, the patient is to remain stationary relative to the alternating-pressure support 1 or guide arrangement.

To this end, a flexible support element cover (not shown) can be provided, by means of which it is possible simultaneously to increase the comfort of the patient and/or the operational safety of the alternating-pressure support 1. In this case, the support element cover is preferably stretched over the support rollers 4 and, for example, secured on the guides 3a, 3b, thus enabling the support rollers 4 to roll on a side facing the support rollers 4, i.e. the underside of the support element cover. The support element cover, which is fixed in location as a result, can not only prevent penetration of objects or body parts into gaps between the support elements 2 but also prevent the patient supported by the support rollers 2 and lying on the support element cover from being moved at the same time during a movement of the support elements 2.

In the example shown in FIG. 1, the guide arrangement has a feed 5a and a return 5b, wherein the feed 5a and the return 5b are arranged one above the other, i.e. in the manner of a stack. A slatted-frame-type configuration of the alternating-pressure support 1 is thereby achieved. In principle, however, other arrangements of the feed and return 5a, 5b relative to one another are also conceivable. In particular, variants without a return 5b are also conceivable (see FIG. 4).

Both the feed 5a and the return 5b have two guides 3a, 3b arranged opposite one another. By means of the feed and return 5a, 5b, the support elements 2 can be moved in a circulating manner, i.e. on a closed path. For example, the support elements 2 can be moved in the longitudinal direction L by means of the feed 5a, e.g. from a foot part 6b of the alternating-pressure support 1 to a head part 6a of the alternating-pressure support 1, while the support elements 2 are fed back from the head part 6a to the foot part 6b counter to the longitudinal direction L by means of the return 5b. It is thereby possible, for example, to continuously stroke blood vessels in the patient's legs toward their torso, in order to reduce a risk of thrombosis for instance.

In the example shown, the guides 3a, 3b are made up of a multiplicity of guide elements 10. Alternatively, however, it is also conceivable for the guides 3a, 3b to consist of just one or a few guide elements 10. In a variant which is not shown, the guides 3a, 3b can each have three guide elements 10. In this case, one of the three guide elements 10 can define the foot part 6b, which can optionally be capable of being raised and/or angled. In this case, another of the three guide elements 10 can define the head part 6a, which can optionally be capable of being raised. The third of the three guide elements 10, which is arranged between the head part 6a and the foot part 6b, can then define a continuous lying or sitting surface.

FIG. 2 shows a detail of FIG. 1 in the region of the foot part 6b of the alternating-pressure support without showing the return. It shows a connection, in particular a chain-type connection, of the support elements 2 by connecting elements 7, which are arranged on the mutually opposite ends (in FIG. 2, only one end 2a of each of the two opposite ends is visible). A chain of support elements 2 which can be moved in the guide 3a is thereby formed. Here, each of the connecting elements 7 is expediently arranged between a support roller 4 and a running roller 8. It is preferred if each of the axle elements 9 has at least one bearing arrangement or a hub, by means of which the support rollers 4 and/or the running rollers 8 are rotatably mounted with respect to the respective axle element 9. It is conceivable, for example, that the support rollers 4 and/or the running rollers 8 are seated on such a bearing arrangement. Accordingly, the connecting elements 7 and/or the running rollers 8, and also the support rollers 4 where applicable, can be fitted or mounted on a respective axle element 9. For example, the running rollers 8 or the support rollers 4 can be fitted or mounted with an interference fit—and/or the connecting elements 7 with a clearance fit—with the respective axle element 9 corotating. If, in contrast, both the running rollers 8 and the support rollers 4 are mounted rotatably on the axle elements 9, the connecting elements 7 can also be fitted or mounted with an interference fit.

By means of the running rollers 8, the support elements 2 are movably mounted in the guide 3a in the preferred manner. In order to permit particularly reliable guidance of the support elements 2, the guide 3a can have a channel-type recess or a groove to receive the running rollers 8 (see FIG. 4).

In an alternative embodiment, the support elements 2 have, instead of the running rollers 8, sliding sections (not shown), which are configured to slide in the guides.

By means of the connecting elements 7, the support elements 2 are arranged so as to be movable relative to one another. This makes it possible for the support elements 2 which are being moved counter to the longitudinal direction L by means of the return (not shown), for example, to be deflected into the feed 5a at the foot part 6b of the alternating-pressure support.

FIG. 3 shows a detail of FIG. 1 in the region of the head part 6a of the alternating-pressure support. Here, the head part 6a is designed in such a way that it can be raised. For this purpose, the guide arrangement has hinge elements 11, e.g. at least one in each guide 3a. Here, each of the hinge elements 11 is preferably configured to enable two adjacent guide elements 10 to tilt relative to one another. By means of such hinge elements 11, the head part 6a can be raised by up to 40°, for example.

FIG. 4 shows an example of an alternating-pressure support 1 without a return. Here, a plurality of support elements 2 is mounted in such a way as to be movable along a longitudinal direction L in two mutually opposite guides 3a, 3b of a guide arrangement and is configured to elastically support a load acting on the support elements 2 on the guide arrangement. In this case, a drive 12 is provided for the longitudinal movement of the support rollers 2.

At the ends, the support elements 2 can engage in a transverse direction Q in corresponding guide grooves 13 of the guides 3a, 3b, e.g. by means of a sliding journal or by means of guide rollers (see FIG. 2). Owing to the perspective illustration, only the guide groove 13 in guide 3b is visible.

The drive 12, a motor for example, is expediently configured for oscillatory movement of the support elements 2 in the guides 3a, 3b, i.e. for the backward and forward movement of the support elements 2.

For this purpose the number of support elements 2 is expediently chosen in such a way that an extent of a lying or sitting surface defined by the support rollers 2 in the longitudinal direction L is smaller than the length of the guides 3a, 3b. Accordingly, there are no support elements 2 between the two guides 3a, 3b in one section. In the state shown in FIG. 1, the lying or sitting surface therefore does not reach as far as the end of a foot part 6b of the alternating-pressure support 1. During a movement of the support elements 2 toward the foot part 6b, this gap between the guides 3a, 3b decreases, however. At the same time, a corresponding gap forms between the guides 3a, 3b in the region of a head part 6a.

An alternating-pressure support 1 designed in this way has the advantage over the alternating-pressure support shown in FIG. 1 that it saves more installation space. The alternating-pressure support 1 shown in FIG. 4 is therefore particularly suitable, for example, for use in wheelchairs, for supporting individual extremities during operations and/or the like.

FIG. 5 shows an example of a support element 2, which is configured for the elastic support of a load acting on it on a guide arrangement (see FIGS. 1 and 4). For this purpose, the support element 2 has a supporting arrangement 20, which is elastically deformable and, as a result, can absorb and, where applicable, damp part of the load acting on the support element 2, in particular shocks that are acting on it.

In the present example, the supporting arrangement is integrated into the support element 2, in particular being installed in the latter. In this case, the supporting arrangement 20 is formed by an elastically deformable foam body 21, hatched in the illustration, which is arranged between an axle element 9 and a support roller 4, which is designed as a round tube and is expediently rigid. As a result, the support element 2 can roll under a patient by means of an external lateral surface of the support roller 4, in particular a support roller cover, while part of the load acting on the support roller 4 is simultaneously absorbed by compression of the foam body 21.

In the example shown, the axle element 9 and the support roller 4 are connected to one another in a rotationally secure manner by the supporting arrangement 20. In other words, the axle element 9 corotates when the support roller 4 rolls under a patient. Running rollers (see FIG. 2) are therefore expediently provided on the ends of the axle element 9, said running rollers being rotatably mounted on the axle element 9 and thus both ensuring the mobility of the support element 2 in the guide arrangement and allowing free rotation of the axle element 9 together with the supporting arrangement 20 and the support roller 4.

Alternatively to the example shown in FIG. 5, provision can also be made for the support roller 4 to be composed entirely of an elastic material, that is to say, for example, to be formed by the foam body 21. In other words, the supporting arrangement 20 can form the support roller. This can be advantageous in respect of the manufacturing process and can allow particularly soft support for a patient.

FIG. 6 shows two examples of a supporting arrangement 20 in a cross section.

In FIG. 6A, the supporting arrangement 20 comprises an elastically deformable profile 22. Here, the profile 22 extends axially, that is to say perpendicularly to the plane of the figure. The supporting arrangement 20 has a radially inner base 20a and a radially outer sleeve 20b. In this case, the base 20a is surrounded by the sleeve 20b at least in some section or sections, but preferably along the entire length of the profile 22. The base 20a and the sleeve 20b are expediently connected to one another by struts 22a of the profile 22. The struts 22a are preferably dimensioned in such a way that they can bend under the action of a force. It is thereby possible to achieve an elastic deformability of the supporting arrangement 20.

The base 20a and the sleeve 20b are expediently of hose-type or tubular design and are advantageously part of the profile 22. This enables the profile 22 to be pulled onto an axle element 9, hatched in the illustration, during assembly, optionally with an interference fit, with the result that the base 20a is seated in a rotationally secure manner on the axle element 9, as shown in FIG. 6A. Alternatively or in addition, a support roller (see FIG. 5) can be slipped onto the profile 22, with the result that the support roller is seated in a rotationally secure manner on the sleeve 20b.

Alternatively, however, it is also conceivable for the profile 22 to be pulled onto a bearing arrangement (cf. FIG. 6B) seated on the axle element 9, with the result that the profile 22—optionally with the support roller—is mounted so as to be rotatable about the axle element 9.

In the example shown, the struts 22a are of web-type design. In other words, the struts 22a extend axially into the plane of the figure between the base 20a and the sleeve 20b. Depending on the desired elasticity, however, it is also possible as an alternative for the struts 22a to be of pillar-type design and to connect the base 20a only at certain points to the sleeve 20b.

In FIG. 6A, the profile 22 is of star-shaped design in cross section. In other words, the struts 22a extend radially in a straight line from the base 20a as far as the sleeve 20b. Alternatively, however, other arrangements and/or shapes of the struts 22a are conceivable.

The supporting arrangement 20 shown in FIG. 6B corresponds substantially to the supporting arrangement shown in FIG. 6A, with the difference that the struts are formed by springs 23a of a spring arrangement 23. The spring arrangement 23 can be arranged radially between a support roller (see FIG. 5) and an axle element 9. For this purpose, the supporting arrangement 20 can have a base 20a and a sleeve 20b surrounding the base 20a, as shown in FIG. 6B. In this case, the base 20a and the sleeve 20b are connected by the springs 23a and are preferably part of the spring arrangement 23.

As likewise shown in FIG. 6B, the base 20a can be seated on a bearing arrangement 24 around the axle element 9, while the support roller is seated in a rotationally secure manner on the sleeve 20b. Alternatively, however, if the axle element 9 is mounted so as to be freely rotatable, it is also possible for the base 20a to be seated directly and in a rotationally secure manner on the axle element 9 (cf. FIG. 6A). It is likewise also conceivable for the springs 23a of the spring arrangement 23 to be secured directly on the axle element 9 and/or the support roller. In this case, the supporting arrangement 20 or the spring arrangement 23 does not have to have a base 20a and/or a sleeve 20b.

FIG. 7 shows an example of a patient bed 50 which has a frame 51 and an alternating-pressure support 1. The alternating-pressure support 1 and the frame 51 are designed in such a way that the alternating-pressure support 1, in particular a guide arrangement having two guides 3a, 3b arranged opposite one another, is at least partially accommodated by the frame 51. In this case, the alternating-pressure support 1 can have a latching or clip mechanism, by means of which the alternating-pressure support 1 can be secured on the frame 51 in such a way that it can be detached nondestructively and/or without tools.

### LIST OF REFERENCE SIGNS

1 alternating-pressure support
2 support element
2a, 2b end
3a, 3b guide
4 support roller
5a, 5b feed, return
6a, 6b head part, foot part
7 connecting element
8 running roller
9 axle element
10 guide element
11 hinge element
12 drive
13 guide groove
20 supporting arrangement
20a, 20b base, sleeve
21 foam body
22 profile
22a strut
23 spring arrangement
23a spring
24 bearing arrangement
40 patient bed
41 frame
L longitudinal direction
Q transverse direction

1-15. (canceled)

16. An alternating-pressure support, comprising:
a guide arrangement having at least two guides disposed opposite one another in a transverse direction, said at least two guides extending in a longitudinal direction; and
a plurality of support elements having opposite ends movably mounted in said at least two guides;
said plurality of support elements configured for elastically supporting a load acting upon said plurality of support elements at said guide arrangement.

17. The alternating-pressure support according to claim 16, wherein at least some of said plurality of support elements have an elastic construction, at least in some section or sections.

18. The alternating-pressure support according to claim 16, wherein at least some of said plurality of support elements each have a respective supporting arrangement, said supporting arrangements being elastically deformable, at least in some section or sections.

19. The alternating-pressure support according to claim 18, wherein:
said plurality of support elements each have an axial part and a shell; and
said supporting arrangements each have:
a base for rotationally secure connection to said axial part,
a sleeve for rotationally secure connection to said shell, and
at least one elastically deformable element connecting said base to said sleeve.

20. The alternating-pressure support according to claim 16, wherein at least some of said plurality of support elements have a respective axle element and at least one respective support roller connected elastically to said axle element.

21. The alternating-pressure support according to claim 20, wherein:
said support rollers are each configured, at least in some section or sections, as a round tube around said axle element;
at least some of said plurality of support elements each have a respective supporting arrangement;
said supporting arrangements being elastically deformable, at least in some section or sections; and
said supporting arrangements are each disposed between a respective axle element and a respective support roller.

22. The alternating-pressure support according to claim 21, wherein said supporting arrangement is seated on said axle element, and said support roller is seated on said supporting arrangement.

23. The alternating-pressure support according to claim 16, wherein at least some of said plurality of support elements each have a respective elastically deformable foam body.

24. The alternating-pressure support according to claim 16, wherein at least some of said plurality of support elements each have a respective elastically deformable profile.

25. The alternating-pressure support according to claim 24, wherein said profile has a star-shaped cross section.

26. The alternating-pressure support according to claim 16, wherein at least some of said plurality of support elements each have a respective spring arrangement.

27. The alternating-pressure support according to claim 16, wherein each of said plurality of support elements has:
an axle element; and
a respective running roller at each of said opposite ends for movable mounting in a respective one of said guides, said running rollers each being connected elastically to a respective one of said axle elements.

28. The alternating-pressure support according to claim 16, wherein said plurality of support elements are configured for performing an oscillatory motion along and counter to the longitudinal direction in alternation.

29. A patient bed, comprising a frame, and the alternating-pressure support according to claim 16, the alternating-pressure support being supported by said frame.

30. A method for operating an alternating-pressure support, the method comprising:
placing a plurality of support elements opposite one another in a longitudinal direction, and orienting the plurality of support elements in a transverse direction;
movably mounting opposite ends of the plurality of support elements in at least two guides of a guide arrangement;
moving the plurality of support elements in the at least two guides; and
using the plurality of support elements to elastically support a load acting upon the plurality of support elements.
